(19) United States
(12) Patent Application Publication
(10) Pub. No.: US 2016/0292612 A1
(43) Pub. Date: Oct. 6, 2016

(54) FORECAST TOOL FOR FINANCIAL SERVICE PROVIDERS

(71) Applicant: VOYA SERVICES COMPANY, Atlanta, GA (US)

(72) Inventors: Jaime Hegarty, West Simsbury, CT (US); Karen M. Inkel, Wethersfield, CT (US); David Linney, Houston, TX (US)

(21) Appl. No.: 14/675,253

(22) Filed: Mar. 31, 2015

(51) Int. Cl. G06Q 10/06

(52) U.S. Cl. CPC G06Q 10/06398

(57) ABSTRACT

A method includes presenting visually, on an interactive user interface, information representing one or more historical metrics and projected performance for a particular provider of a financial service. The method also includes receiving, via the interactive graphical user interface, one or more inputs from a user. The method also includes updating the projected performance of the particular provider based on the inputs received from the user, and presenting visually, on the interactive user interface, the updated projected performance of the particular provider.

### TECHNICAL FIELD

This disclosure relates to monitoring and forecasting the business performance of a financial service provider.

### BACKGROUND

Various entities can provide financial services to one or more individuals or organizations. Financial service providers can include, for instance, financial advisors, financial institutions, investment brokers, or other individuals or organizations. In some cases, a financial service provider can provide an individual or an organization with a financial perspective regarding the past and current state of the individual's or organization's finances, and a projection of a future state of those finances.

As an example, a financial advisor is a professional who renders financial services to clients. In some cases, a financial advisor can provide banking services, investment and brokerage services, wealth management services, financial planning services, or other service pertaining to the management of finances. A financial advisor also can sell or provide financial products. For example, in some cases, a financial advisor can sell or provide securities, insurance, annuities, retirement plans, or other financial products.

### SUMMARY

This disclosure describes various implementations for monitoring and forecasting the business performance of a financial service provider, such as a financial advisor or brokerage service. In general, the business performance of a financial service provider relies on several factors, each of which can change over the course of the financial service provider's practice. As such, it often is useful to track these factors over the course of time such that the financial advisor or other financial service provider can understand the current state of her business and monitor the progression of her business as it develops. Also, it often is useful to forecast each of these factors, such that the financial service provider can predict the future performance of her business and identify ways in which the business can be improved.

In general, in an aspect, a method includes presenting visually, on an interactive user interface, information representing one or more historical metrics and projected performance for a particular provider of a financial service. The method also includes receiving, via the interactive graphical user interface, one or more inputs from a user. The method also includes updating the projected performance of the particular provider based on the inputs received from the user, and presenting visually, on the interactive user interface, the updated projected performance of the particular provider.

In general, in another aspect, an apparatus includes an interactive user interface, a processor, and a computer-readable medium storing instructions. The instructions, when executed by the processor, causes the processor to perform operations includes presenting visually, on the interactive user interface, information representing one or more historical metrics and projected performance for a particular provider of a financial service updating the projected performance of the particular provider based on inputs entered by the user via the interactive graphical interface, and presenting visually, on the interactive user interface, the updated projected performance of the particular provider.

In general, in another aspect, a system includes a database module configured to store one or more historical metrics pertaining to a plurality of providers of financial services, an interactive user interface, and a processing module communicatively coupled to the database module and the interactive user interface, the processing module. The processing module is configured to receive, from the database module, one or more historical metrics pertaining to a particular provider, determine, based on the one or more historical metrics pertaining to a particular provider, a projected performance for the particular provider, and present visually, on the interactive user interface, information representing one or more historical metrics and projected performance for the particular provider. The processor is also configured to update the projected performance of the particular provider based on inputs entered by the user via the interactive graphical interface, and present visually, on the interactive user interface, the updated projected performance of the particular provider.

Implementations of these aspects may include or more of the following features.

In some implementations, the one or more inputs from the user can include information pertaining to a projected hiring of an employee. The one or more inputs from the user can further include information pertaining to a projected regional expense associated with the hiring of the employee. Updating the projected performance of the particular provider based on the inputs received from the user can include determining the projected performance of the particular provider in hiring the employee.

In some implementations, the one or more historical metrics can include at least one of a historical surrender rate, a historical sales growth rate, and a historical recapture rate.

In some implementations, the one or more inputs from the user can include at least one override value corresponding to a historical metric. Updating the projected performance of the particular provider based on the inputs received from the user can include replacing one of the historical metrics with a corresponding override value, and re-determining the projected performance of the particular provider based at least on the override value and unmodified historical metrics of the particular provider.

In some implementations, the one or more inputs from the user can include at least one override value corresponding to an anticipated future metric for the particular provider. Updating the projected performance of the particular provider based on the inputs received from the user can include re-determining the projected performance of the particular provider based at least on the anticipated future metric and the historical metrics of the particular provider.

In some implementations, the historical metrics for the particular provider can be determined based on information regarding one or more clients of the particular provider, assets associated with those one or more clients, and financial transactions associated with those one or more clients.

In some implementations, the projected performance of the particular provider can include at least one member of a projected income of the particular provider, a projected revenue generated by the particular provider, a projected profitability of a particular provider, and a projected value of assets managed by the particular provider.

In some implementations, the projected performance of the particular provider can include projected demographics of the particular provider's clients. The projected demographics can include a projected number of clients in each of a plurality of categories. The categories can include a plurality of different age ranges. The projected demographics can include a projected value of assets associated with clients in each of a plurality of categories.

The details of one or more implementations are set forth in the accompanying drawings and the description below. Other aspects, features, and advantages will be apparent from the description and drawings, and from the claims.

### BRIEF DESCRIPTION OF THE DRAWINGS

FIG. 1 is a diagram of an example system for monitoring and forecasting the business performance of a financial advisor's professional practice.

FIG. 2 is a diagram of an example analysis module.

FIG. 3A is a diagram of an example user interface element for showing summary information regarding a financial advisor and the business performance of his practice.

FIGS. 3B-F are diagrams of portions of the example user interface element shown in FIG. 3A.

FIG. 4 is a diagram of an example user interface element for allowing a user to input information regarding a financial advisor and his practice.

FIG. 5A is a diagram of an example user interface element for forecasting a financial advisor's business performance.

FIGS. 5B-D are diagrams of portions of the example user interface element shown in FIG. 5A.

FIG. 6 is a diagram of an example user interface element for forecasting the demographics of a financial advisor's clients.

FIG. 7A-F are diagrams of an example user interface element for forecasting the effects of a financial advisor hiring new employees to assist him in his practice

FIGS. 8A-C are diagrams of other example systems for monitoring and forecasting the business performance of financial advisor's professional practice.

FIG. 9 is a diagram of an example computer system.

### DETAILED DESCRIPTION

This disclosure describes various implementations for monitoring and forecasting the business performance of a financial service provider. Although the detailed description below describes example implementations for monitoring and forecasting the business performance of a financial advisor, these are provided merely as illustrative examples. Implementations also can be used to monitor and forecast the business performance of other types of financial service providers, including financial institutions, investment brokers, or other individuals or organizations. Further, some implementations can be used to monitor and forecast the business performance of sub-section of one or more financial service providers, for example a portion of an individual's business (e.g., a portion of a business pertaining to particular services or products provided by that individual) or a portion of an organization's business (e.g., a portion of business, such as a department or business unit, pertaining to a particular group of employees, market, or geographical region associated with the organization).

The business performance of a financial advisor's professional practice relies on several factors, including the number of clients that she services, the products and services that she sells (either to the client or on behalf of the client), and the expenses that she incurs in providing those products and services. Each of these factors potentially can change over the course of the financial advisor's practice. As such, it often is useful to track these factors over the course of time, such that the financial advisor can understand the current state of her business and monitor the progression of her business as it develops. Also, it often is useful to forecast each of these factors, such that the financial advisor can predict the future performance of her business and identify ways in which the business can be improved.

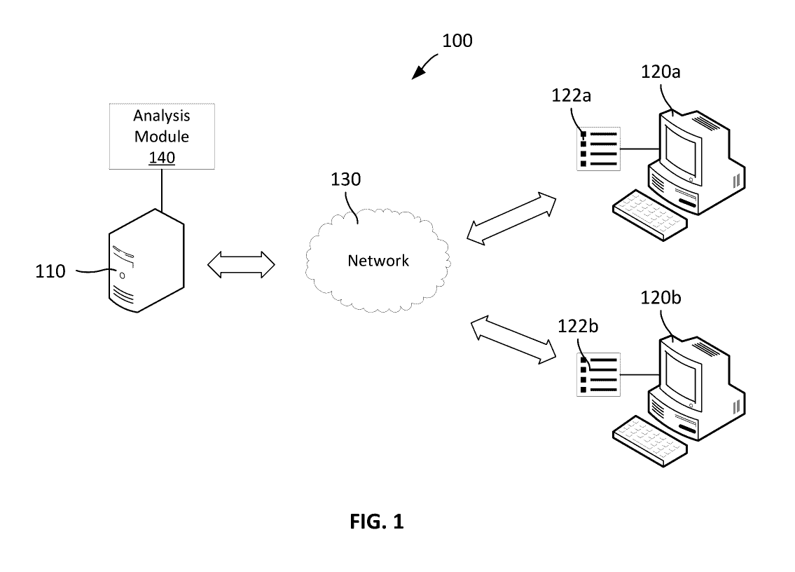

An example system 100 for monitoring and forecasting a financial advisor's business performance is shown in FIG. 1. In some implementations, the system 100 can provide information pertaining to a single financial advisor. As an example, a single financial advisor can use the system 100 in order to obtain historical, current, and projected information regarding his practice. In some cases, the system 100 also can provide customized information for each of several financial advisors who could, for example, be working individually or collaboratively. As an example, the system 100 can be used to monitor several financial advisor's professional practices, and provide customized historical, current, and projected information regarding each practice's individual or collective business performance.

The system 100 includes a server system 110 and client devices 120a-b that are communicatively connected through a network 130. The system 100 also includes an analysis module 140 maintained on the server system 110.

Each client device 120a-b includes a user interface 122a-b. Users can interact with user interfaces 122a-b in order to view data (e.g., data on the server system 110 and the analysis module 140 and/or data on client devices 120a-b), transmit data to other devices (e.g., to the server system 110 and the analysis module 140 and/or to other client devices 120a-b), and issue commands (e.g., to the server system 110 and the analysis module 140 and/or or to the client devices 120a-b). In some implementations, a user may install a software application (e.g., a general web browser or a dedicated software application) onto a client device 120a-b in order to facilitate performance of these tasks.

The server system 110 transmits information to and/or receives information from the client computers 120a-b. The server system 110 is illustrated as a single component, but can be implemented on one or more computing devices. The server system 110 can be, for instance, a single computing device that is connected to the network 130, and the analysis module 140 can be maintained and operated on the single computing device. In some implementations, the server system 110 can include multiple computing devices that are connected to network 120, and the analysis module 140 can be maintained and operated on some or all of the computing devices. For instance, the server system 110 can include several computing devices, and the analysis module 140 can be distributive on one or more of these computing devices. In some implementations, the server system 110 need not be located locally with respect to the rest of system 100, and portions of the server system 110 can be located at one or more remote physical locations.

A client device 120a-b can be any electronic device that is used by a user to view, process, transmit and receive data. Examples of client devices 120a-b include computers (e.g., desktop computers, notebook computers, server systems, etc.), mobile computing devices (e.g., cellular phones, smartphones, tablets, personal data assistants, notebook computers with networking capability), and other computing devices capable of transmitting and receiving data from the network 130. The client devices 120a-b can include devices that operate using one or more operating systems (e.g., Microsoft Windows, Apple OSX, Linux, Unix, Android, iOS, etc.) and/or architectures (e.g., x86, PowerPC, ARM, etc.) In some implementations, one or more client devices 120a-b need not be located locally with respect to the rest of system 100, and one or more client devices 120a-b can be located at one or more remote physical locations.

The network 130 can be any communications network through which data can be transferred and shared. For example, the network 130 can be a local area network (LAN) or a wide-area network (WAN), such as the Internet. The network 130 can be implemented using various networking interfaces, for instance wireless networking interfaces (e.g., WiFi, Bluetooth, or infrared) or wired networking interfaces (e.g., Ethernet or serial connection). The network 130 also can include combinations of more than one network, and can be implemented using one or more networking interfaces.

In general, the analysis module 140 monitors and forecasts the business performance of a financial advisor's professional practice. As an example, the analysis module 140 can receive and store information pertaining to a financial advisor, her practice as a financial advisor, and the business performance of her practice. The analysis module 140 also can process this information, and present it to a user (e.g., the financial advisor or her representative), such that the user can more readily identify and understand key aspects of the information. As an example, the analysis module 140 can interpret the information in order to generate a summary of the business performance of a financial advisor's practice, and highlight particular factors that affected that business performance. The analysis module 140 also can estimate the future business performance of the financial advisor's practice and identify ways in which the performance can be improved.

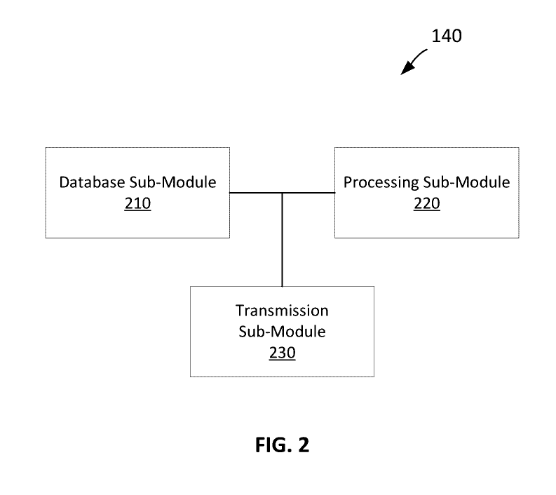

FIG. 2 shows various aspects of the analysis module 140. The analysis module 140 includes several sub-modules that perform particular functions related to the operation of the system 100. For example, the analysis module 140 can include a database sub-module 210, a processing sub-module 220, and a transmission sub-module 230.

The database sub-module 210 maintains information related to one or more financial advisors and their respective practices. For instance, the database sub-module 210 can store information such as a financial advisor's identity (e.g., name, address, contact information, and so forth), and access credentials that allow the financial advisor to access the system 100 (e.g., a user name and password). The database sub-module 210 also can store information regarding a financial advisor's practice. As an example, this information can include information regarding the financial advisor's clients (e.g., the identity of the clients, demographic information regarding those clients, contact information regarding those clients, the financial assets of those clients, the services and products being provided by the financial advisor to those clients, financial transactions conducted on behalf of those clients, and so forth). As another example, this information can include information regarding the business performance of the financial advisor's practice (e.g., information regarding the financial assets that the financial advisor is managing for this clients, the amount of revenue and monetary compensation that the financial advisor has generated in providing his services and products, the expenses that financial advisor has incurred in providing his services and products, and so forth). The database sub-module 210 can store historical information regarding each financial advisor and his practice. For example, the database sub-module 210 can store records regarding the financial advisor's clients and the performance of the financial advisor's practice on a recurring basis (e.g., weekly, monthly, quarterly, yearly, and so forth), such that information is available regarding multiple points of time (or periods of time) in the past.

The processing sub-module 220 processes data stored by or otherwise accessible to the system 100. For instance, the processing sub-module 220 can execute automated or user-initiated processes that manipulate data pertaining to one or more financial advisors, their clients, and/or their practice. As an example, the processing module 220 can manipulate data stored on the database sub-module 220 in order to generate a summary of the information stored on the database sub-module 220, or an analysis of the information stored on the database sub-module 220. In some cases, the processing sub-module 220 can perform processes that are customized with respect to one or more criteria. For example, in some cases, the processing sub-module 220 can summarize and/or analyze data associated with one or more particular financial advisors, clients, and/or practices. Example processes that can be performed by the processing sub-module 220 are described in greater detail below.

The transmission sub-module 230 allows for the transmission of data to and from analysis module 140. For instance, the transmission sub-module 230 can be communicatively connected to network 130, such that it can transmit data to the client devices 120a-b and/or receive data from the client devices 120a-b via network 130. As an example, information inputted by users on the client devices 120a-b can be transmitted to the analysis module 140 through the transmission sub-module 230. This information can then be processed (e.g., using the processing sub-module 220) and/or stored (e.g., using the database sub-module 210). As another example, information from the analysis module 140 (e.g., information stored on the database sub-module 210) can be transmitted to one or more client devices 120a-b through transmission sub-module 230.

As described above, the analysis module 140 monitors and forecasts a financial advisor's business performance, and displays this information to a user (e.g., a financial advisor, her representative, an administrator, or some other user) for review. This information can be presented, for example, using the user interfaces 122a-b on the client devices 120a-b. As an example, information obtained from the analysis module 140 (e.g., information stored by the database sub-module 210 and/or information received by the transmission sub-module 230) and can be used to generate graphical, textual, and/or auditory information (e.g., using the processing sub-module 220). This processed information then can be transmitted to the client computers 120a-b (e.g., using the transmission sub-module 230), and presented to the user using the user interfaces 122a-b.

In some cases, the user interfaces 122a-b can include one or more user interface elements (e.g., visual “windows,” “panels,” “pages,” or “tabs”) that visually represent some or all of this information in a form that can be readily viewed and understood by a user. Users can selectively retrieve certain user interface elements in order to view particular information of interest. For example, in some cases, the user interfaces 122a-b can include several graphical “windows,” each of which contains particular information. A user can select a particular “window” (e.g., by selecting that window with an input device, such as a keyboard or mouse), such that the information within the selected “window” is presented on the user interface 122a-b. As another example, in some cases, the user interfaces 122a-b can include several graphical “tabs,” each of which corresponds to a particular “page” of information. A user can select a particular “tab” (e.g., by selecting that tab with an input device), such that the information within the corresponding “page” is presented on the user interface 122a-b. Although example implementations of user interface elements are described above, other implementations are also possible.

Although specific user interface elements are described and illustrated, these are merely examples to illustrate types of information that may be received, stored, determined, or presented by the system 100. In practice, the system 100 can include all of the described information or sub-sets of the described information, depending on the implementation. Further, although specific arrangements of user interface elements are described, these also are merely examples to illustrate how information may be arranged and presented by the system 100. In practice, the system 100 can arrange and present information in other ways, depending on the implementation.

In some implementations, a user interface element can show summary information regarding a financial advisor and the business performance of her practice.

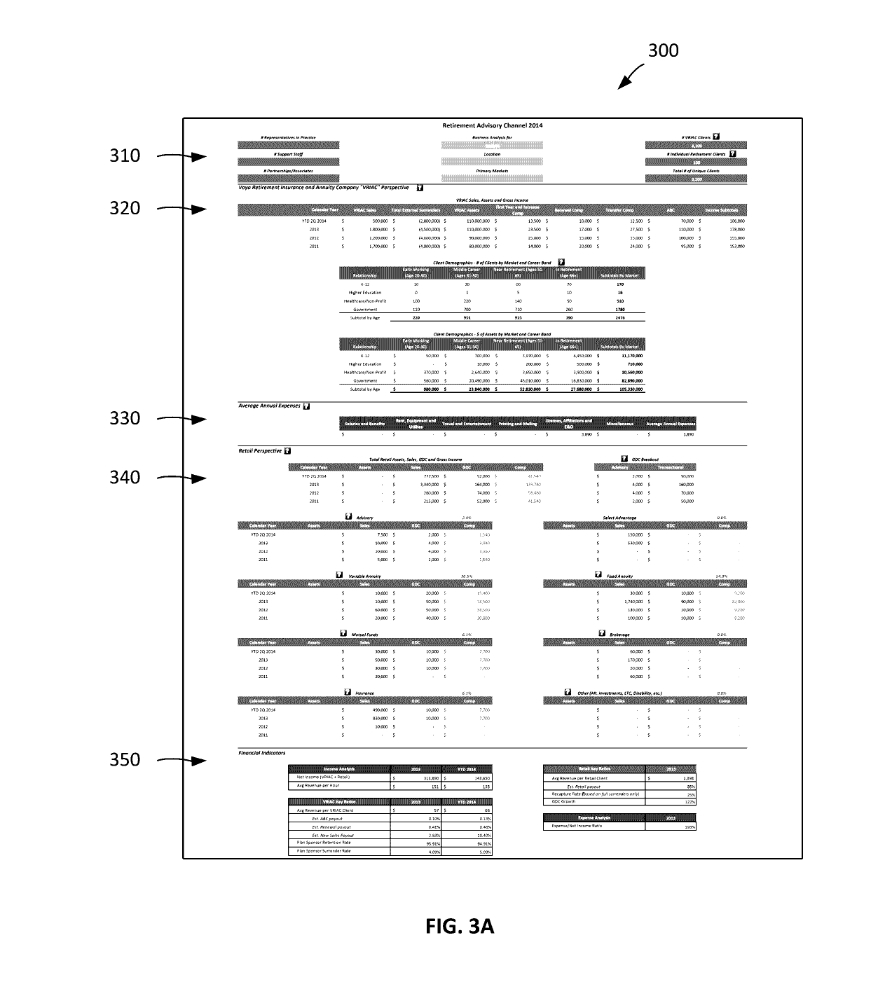

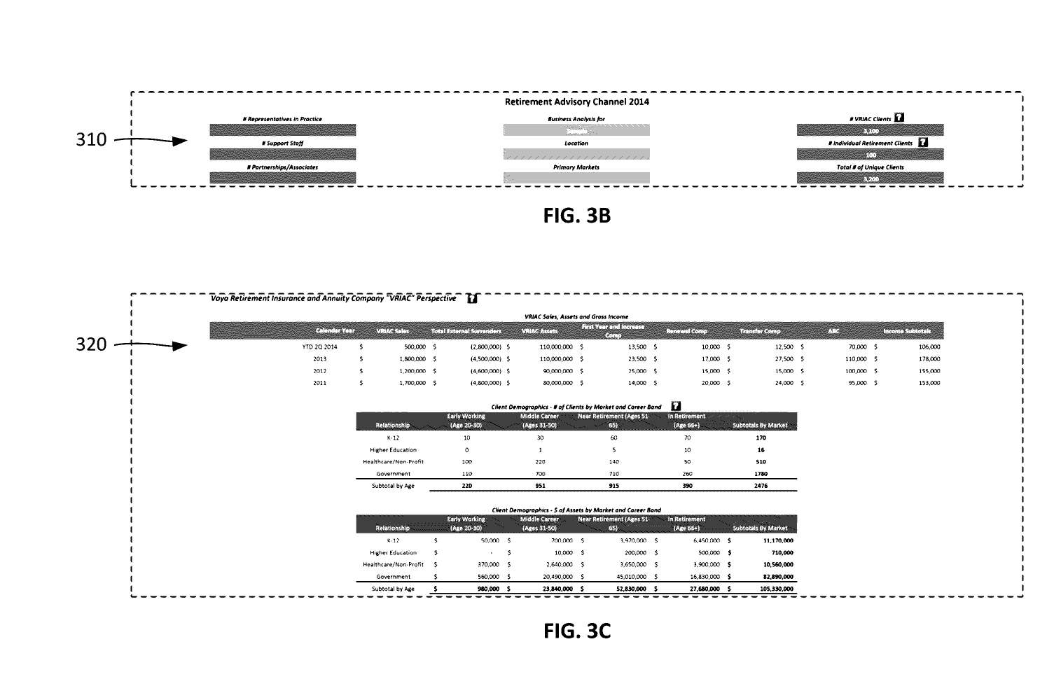

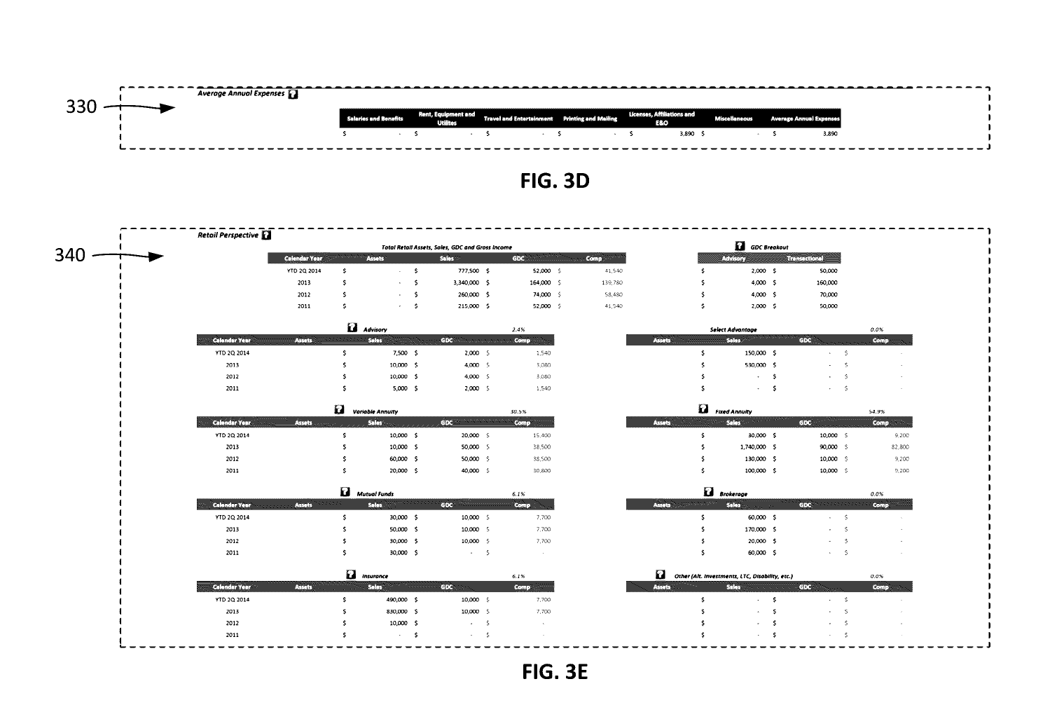

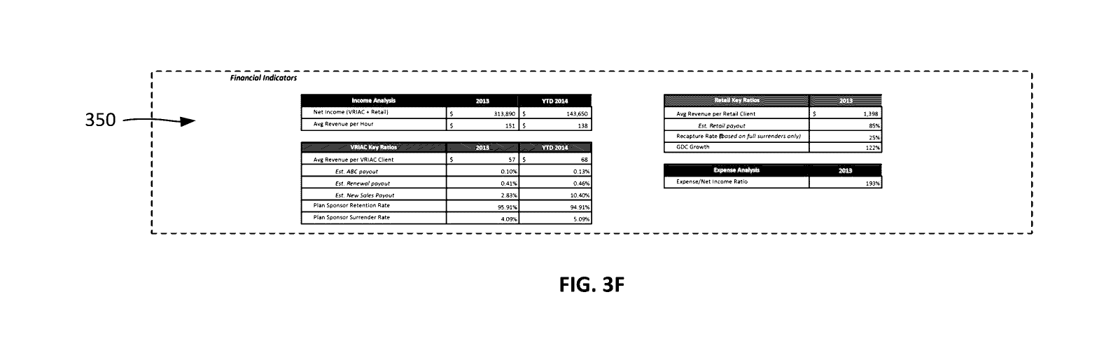

An example summary user interface element 300 is shown in FIG. 3A. The summary user interface element 300 can include one or more sub-elements each of which presents a particular type of information. For example, the summary user interface element 300 can include a general information sub-element 310, a sponsor and demographic sub-element 320, an expenses sub-element 330, a retail perspective sub-element 340, and a financial metrics sub-element 350. Each of these sub-elements is shown in greater detail in FIGS. 3B-F.

Referring to FIG. 3B, the general sub-element includes general information regarding the financial advisor's practice. This can include, for example, information regarding the number of employees that are employed as part of the financial advisor's practice (e.g., representatives, support staff, partners, associates, or any other employees associated with the financial advisor's practice). The summary sub-element 310 also can include information regarding the clients that the financial advisor services as part of her practice (e.g., the number of clients that the financial advisor services and the general type of services that they receive). The summary sub-element 310 also can include information regarding the financial advisor's name, the location of his practice (e.g., a particular address, city, state, or region), and/or information regarding the business lines or products in which his practice is active (e.g., tax exempt markets, corporate markets, retail, and so forth).

Referring to FIG. 3C, the sponsor and demographic sub-element 320 includes information regarding the business performance of aspects of the financial advisor's practice pertaining to a particular business or organization. As an example, in some cases, the financial advisor may provide products and services related to a particular company or organization (e.g., a company or organization offering particular retirement and annuity products). In this case, the sponsor and demographic sub-element 320 can include information that summarizes the business performance of the financial advisor in providing those particular financial services and products to clients. Thus, sponsor and demographic sub-element 320 can include, for example, information regarding the sales, assets, and gross income generated by the financial advisor's sale of the company's products or services, as well as the amount of assets that were “surrendered” by the financial advisor (e.g., assets that are no longer managed by the financial advisor and the company, such as those that were withdrawn by a client). The sponsor and demographic sub-element 320 also can include, for example, information regarding the financial advisor's clients (e.g., the number of clients in each of several categories, such as age groups and/or markets, the assets of those clients in each of the categories, and so forth) who are receiving products and/or services associated with the company.

The information shown in the sponsor and demographic sub-element 320 also can be aggregated over recurring periods of time (e.g., quarterly or yearly), such that the information is provided for each of several successive periods of time that the financial advisor has practiced. As an example, information regarding the financial advisor's business performance in providing the company's products and services can be displayed for each of several years in the past. Information regarding the financial advisor's business performance for the current period of time (e.g., a quarter or year to date) also can be displayed.

Referring to FIG. 3D, the expenses sub-element 330 includes information regarding the financial advisor's expenses that she incurs in providing services and products to his clients. Thus, the expenses sub-element 330 can include, for example, information regarding expenses such as the salaries and benefits that the financial advisor pays to her employees, rental equipment and utility expenses that she incurs in operating her practice, and travel and entertainment expenses. The expenses sub-element 330 also can include, for example, printing and mailing expenses, licensing expenses, affiliation expenses, insurance expenses (e.g., liability insurance such as error and omissions insurance), miscellaneous expenses, or any other expenses related to the financial advisor's practice.

Referring to FIG. 3E, the retail perspective sub-element 340 includes information regarding the financial advisor's retail products and services. As an example, in some cases, if the financial advisor provides products and services related to a particular company or organization (e.g., those summarized in the sponsor and demographic sub-element 320), but also provides additional products and services that are not directly associated with that company or those products, the retail perspective sub-element 340 can include information regarding the business performance of the portion of the financial advisor's practice pertaining providing those additional products and services. Examples of retail services and products includes advisory services (e.g., financial planning services), annuities (e.g., variable and fixed annuities), mutual funds, brokerage services, insurance, bonds, alternative investments, disability benefits, long term care benefits, and so forth. Example information includes the assets that the financial advisor is managing on behalf of his clients, the revenue that the financial advisor generates by selling products and services, the gross dealer concession associated with the sales (e.g., the amount of money that the financial advisor's company is paid by the sales of the products and services), and the compensation that the financial advisor generates as a result of the sales for each of the retailer categories.

The information shown in the retailer perspective sub-element 340 can be presented individually for each of the financial advisor's retail categories, and/or aggregated across some or all of the financial advisor's retail categories. This information also can be aggregated over recurring periods of time (e.g., quarterly or yearly), such that the information is provided for each of several successive periods of time that the financial advisor has practiced. As an example, information regarding the financial advisor's business performance in each of several retail categories can be displayed for each of several years in the past, along with an aggregation of his overall business performance in each of those years in the past. Information regarding the financial advisor's business performance for the current period of time (e.g., a quarter or year to date) also can be displayed.

Referring to FIG. 3F, the financial metrics sub-element 350 includes information that might be a particular importance in assessing the business performance of a financial advisor's practice. For example, the financial metrics sub-element 350 can include an analysis of the financial advisor's income over one or more years. This can include a calculation of the financial advisor's net income (e.g., the income that he received in providing the company's products and services and additional retail products and services), and a calculation of his average revenue per hour of work. The financial metrics sub-element 350 also can include an analysis of the financial advisor's expenses (e.g., a ratio between the expenses and net income of the financial advisor).

Further, the financial metrics sub-element 350 also can include the calculation of various ratios or other indicators specific to each aspect of the financial advisor's practice. For instance, for products and services provided by a particular company (e.g., those summarized in the sponsor and demographic sub-element 320), the financial metrics sub-element 350 can include information regarding the average revenue that the financial advisor generated per client, an average profitability of the financial advisor, an estimated renewal payout, and an estimated new sales payout. The financial metrics sub-element 350 also can include a plan sponsor retention rate, and a plan sponsor surrender rate.

For additional retail products and services (e.g., those summarized in the retail perspective sub-element 340), the financial metrics sub-element 350 can include information regarding the average revenue that the financial advisor generated per client, and an estimate of the retail payout. The financial metrics sub-element 350 also can include a recapture rate, and a calculation of the growth in the gross dealer concession.

Although various types of information are described above, these are merely illustrative examples. In practice, the summary user interface element 300 can include additional information, either in addition to or instead of that described above. For example, although example financial figures and indicators are shown, one or more additional financial figures and/or indicators also can be used, either in addition to or instead of those described above.

In general, the information shown in the summary user interface element 300 can be determined based on information stored in the database sub-module 210. For example, the database sub-module 210 can contain records describing each aspect of a financial advisor's practice, including records of the assets managed by the financial advisor, the transactions conducted with respect to those assets, the clients associated with the assets, and so forth. Using these records, the processing sub-module 220 can generate the appropriate information for display on the summary user interface element 300. Records describing the financial advisor's practice can be obtained automatically (e.g., from a record keeping module on the server system 110, or from a record keeping system communicatively coupled to the system 100), and/or manually entered by a user (e.g., a user inputting data using the server system 110, client computers 120a-b, or some other device).

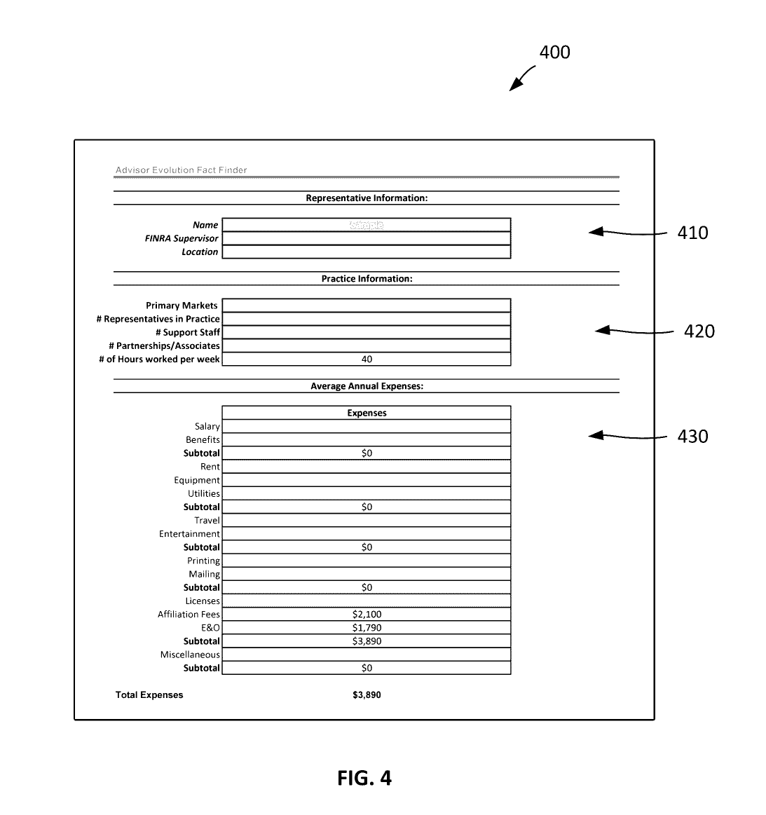

In some implementations, a user interface element can allow a user to input information regarding the financial advisor and her practice. As an example, referring to FIG. 4, an input user interface element 400 can include several input fields that allow a user (e.g., a financial advisor, a financial institution, or a business unit) to input various information pertaining to her practice. For instance, the input user interface element 400 can include input fields 410 that allow the financial advisor to input general information regarding herself, such as her name, the name of her supervisor, and the location in which she practices. As another example, the input user interface element 400 can include input fields 420 that allow the financial advisor to input general information regarding her practice, such as the markets in which she practices, the number of employees that work for her (e.g., the number of representations, support staff, partners, associates, or other employees), and the number of hours that she works in a week. The input user interface element 400 also can include input fields 430 that allow the financial advisor to input information regarding the expenses that he incurs in providing services and products to his clients. This can include, for example, information regarding expenses such as the salaries and benefits that the financial advisor pays to his employees; rental, equipment and utility expenses that he incurs in operating his practice; and travel and entertainment expenses. As another example, this can also include printing and mailing expenses, licensing expenses, affiliation expenses, insurance expenses (e.g., liability insurance such as error and omissions insurance), miscellaneous expenses, or any other expenses related to the financial advisor's practice.

Information entered into the input user interface element 400 can be used to modify the information shown in the summary user interface element 300. For example, when a user enters information input the input fields 410 and 420 (e.g., her name, her location, the number of employees, and so forth), the summary sub-element 310 can be updated to reflect those inputs. As another example, when the user enters information input the input fields 430 (e.g., expense information), the expenses sub-element 330 and the financial metrics sub-element 350 can be updated to reflect those inputs. In some cases, entering information into the input user interface element 400 can cause, in response, an automatic recalculation and re-display of the figures presented in the summary user interface element 300. For example, when the user inputs new or modified information into the input fields 430 (e.g., to enter new or updated expense information), the information shown in the financial metrics sub-element 350 (e.g., the income analysis and the expense ratio) can be recalculated and displayed to reflect those inputs.

Although various information and inputs are described above, these are merely illustrative examples. In practice, the input user interface element 400 can include additional information and inputs, either in addition to or instead of those described above. For example, although example input fields are shown for inputting certain types of information, one or more additional input fields also can be used to input other types of information, either in addition to or instead of those described above.

As described above, the analysis module 140 also can forecast a financial advisor's business performance, and can display this information to a user for review (e.g., using a user interface element presented by a user interface 122a-b). In some cases, the analysis module 140 can forecast a financial advisor's business performance by leveraging historical metrics regarding that financial advisor and/or historical metrics of one or more other financial advisors over a particular period of time (e.g., several days, months, or years). The analysis module 140 can, for example, forecast a financial advisor's business performance based, at least in part, on the information shown in a summary user interface element and/or on the underlying data used to determine this information. The analysis module 140 also can, for example, to forecast a financial advisor's business performance based, at least in part, on additional information not shown or reflected in the summary user interface element.

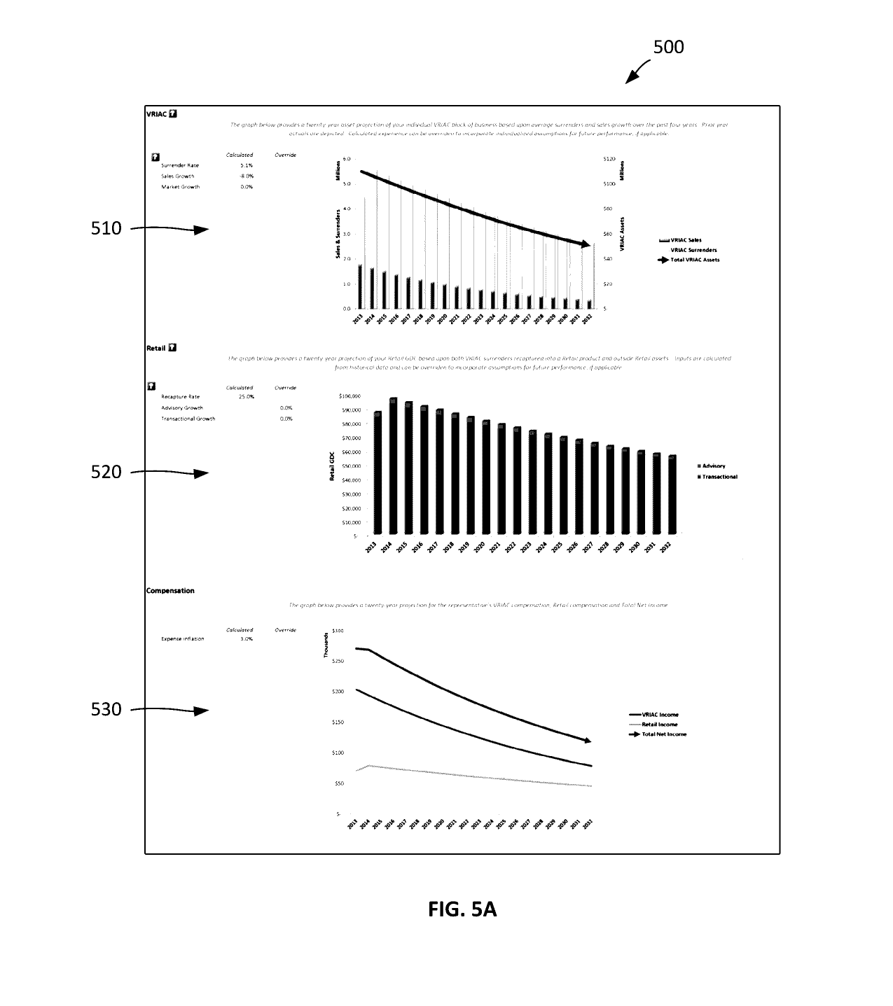

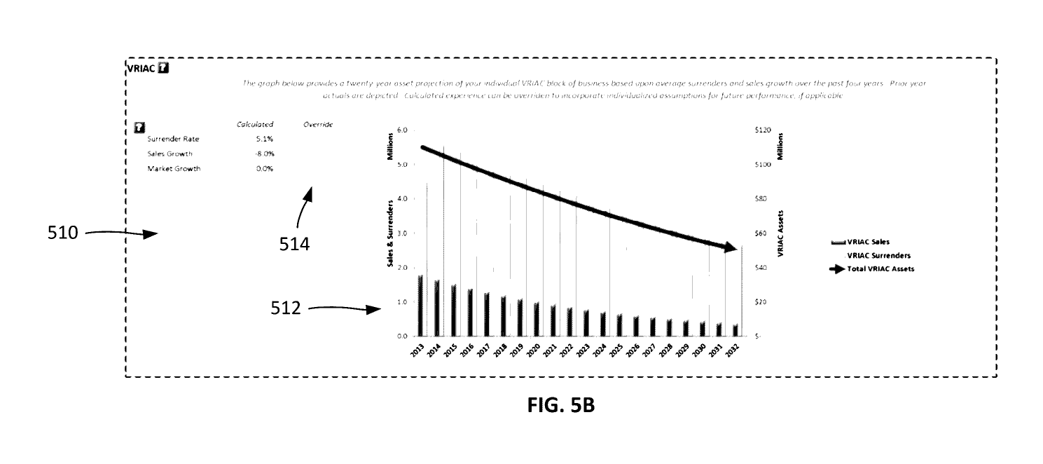

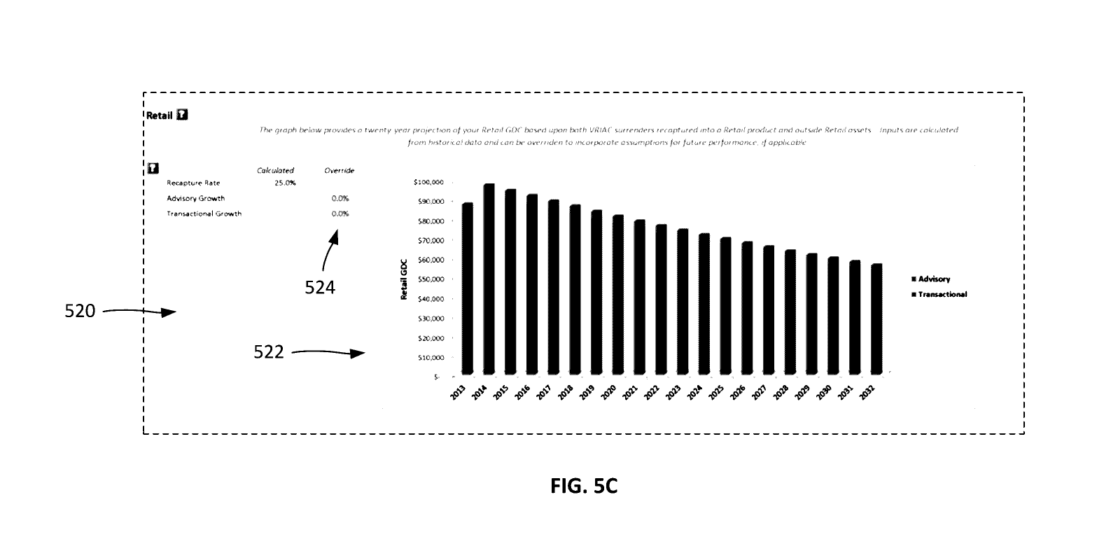

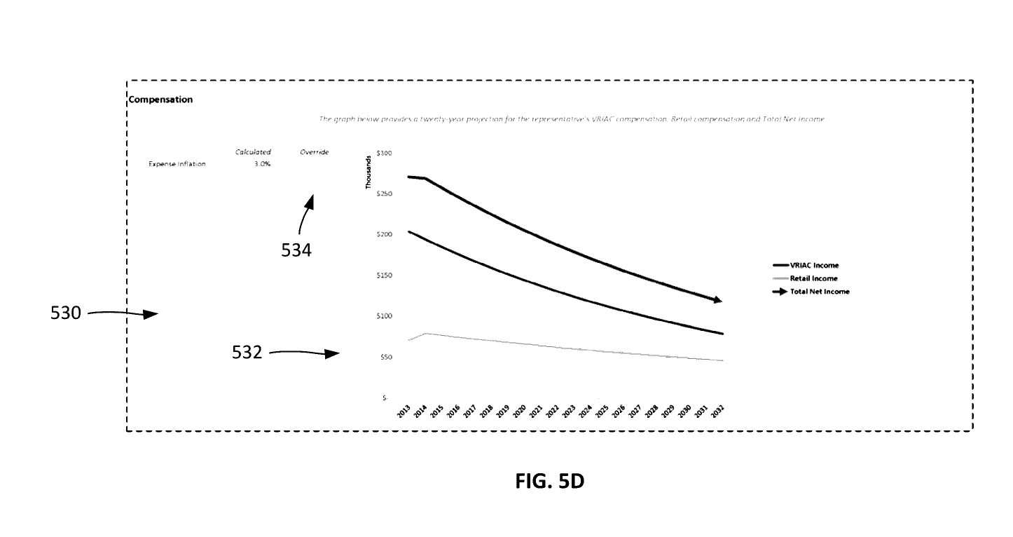

An example business forecasting user interface element 500 is shown in FIG. 5A. The business forecasting user interface element 500 can include one or more sub-elements each of which presents a particular type of information. For example, the business forecasting user interface element 500 can plan sponsor forecasting sub-element 510, a retailer forecasting sub-element 520, and a combined income forecasting sub-element 530. Each of these sub-elements is shown in greater detail in FIGS. 5B-D.

In general, the information shown in business forecasting user interface element 500 can be determined, at least in part, based on information stored in the database sub-module 210 relevant to each particular financial advisor. For example, the database sub-module 210 can contain records describing each aspect of a financial advisor's practice, including records of the assets managed by the financial advisor, the transactions conducted with respect to those assets, the clients associated with the assets, surrender rate of the plan sponsor assets, payouts by the user, and so forth. Using these records, the processing sub-module 220 can generate the appropriate information for display on the business forecasting user interface element 500. Records describing the financial advisor's practice can be obtained automatically (e.g., from a record keeping module on the server system 110, or from a record keeping system communicatively coupled to the system 100), and/or manually entered by a user (e.g., a user inputting data using the server system 110, client computers 120a-b, or some other device).

Referring to FIG. 5B, the plan sponsor forecasting sub-element 510 includes a financial forecast of aspects of a financial advisor's plan sponsor practice (e.g., a forecast of the information summarized in the sponsor and demographic sub-element 320 and financial metrics sub-element 350). As described above, in some cases, the financial advisor may provide products and services related to a particular company or organization (e.g., a company or organization offering particular retirement and annuity products). In this case, plan sponsor forecasting sub-element 510 can include a forecast of the business performance of the financial advisor in providing those particular financial services and products to clients in the future.

In the example shown in FIG. 5B, the plan sponsor forecasting sub-element 510 includes a chart 512 indicating the financial advisor's estimated business performance during a particular length of time in the future (e.g., ten years in the future, twenty years in the future, or some other time in the future). For example, the chart 512 includes an estimate of the sales of services and products that the financial advisor will complete in the future, an estimate of the surrenders that the financial advisor will experience in the future (e.g., assets that are withdrawn from the financial advisor's management, such as due to withdrawal by the client), and an estimate of the total assets that the advisor will be managing in the future.

The forecasting shown in the plan sponsor forecasting sub-element 510 depends, at least in part, on the historical performance of the financial advisor, and assumed performance characteristics for the financial advisor moving forward. For example, the forecast can depend on current business performance of the financial advisor, an assumed surrender rate for the financial advisor, an assumed sales growth rate for the financial advisor, and an assumed growth rate of the market.

The assumed surrender rate is an estimate of the rate at which assets will be withdrawn from the financial advisor's management (e.g., due to withdrawal by the client). In some cases, the assumed surrender rate can be determined based on historical information. For example, the assumed surrender rate can be calculated by averaging the surrender rate of the financial advisor over a period of time in the past (e.g., over the past year, two years, three years, or any other time period). The surrender rate can be determined, in some cases, by determining the ratio of the value of the surrendered assets divided by the total value of the assets managed by the financial advisor over that time period. In some cases, the assumed surrender rate can be set to a particular default value (e.g., 0%).

The assumed sales growth rate is an estimate of the rate at which the financial advisor will increase his sales of products and services to clients. In some cases, the assumed sales growth rate can be determined based on historical information. For example, the assumed sales growth rate can be calculated by averaging the rate of the financial advisor's rate of sales growth over a period of time in the past (e.g., over the past year, two years, three years, or any other time period). In some cases, the assumed sales growth rate can be set to a particular default value (e.g., 0%).

The assumed market growth rate is an estimate of the rate at which the market as a whole will grow. In some cases, the assumed market growth rate sales growth rate can be determined based on historical information. For example, the assumed sales growth rate can be calculated by averaging the rate of the overall market's growth over a period of time in the past (e.g., over the past year, two years, three years, or any other time period). In some cases, the assumed market growth rate can be set to a particular default value (e.g., 0%). In some cases, the assumed market growth rate can be set to a value that reflects the actual market growth rate for the company as a whole.

In some cases, a user can override the calculated or default values by entering override values input the input fields 514. For example, the user can enter a new assumed surrender rate, a new assumed sales growth rate, and/or an assumed market growth rate. As the user enters one or more override values, in response the data in the chart 512 automatically updates to reflect the new assumed values. This allows the user to forecast how his business performance based on one or more hypothetical situations, or incorporate individualized assumptions for future performance.

Referring to FIG. 5C, the retailer forecasting sub-element 520 includes a financial forecast of aspects of a financial advisor's practice pertaining to retail products and services (e.g., a forecast of the information summarized in the retailer perspective sub-element 340). As described above, in some cases, the financial advisor may provide products and services related to a particular company or organization (e.g., a company or organization offering particular retirement and annuity products), but also provides additional products and services that are not directly associated with that company or that company's products. In this case, the retailer forecasting sub-element 520 can include a forecast of the business performance of the financial advisor in providing those additional retail financial services and products to clients in the future.

In the example shown in FIG. 5C, the retailer forecasting sub-element 520 includes a chart 522 indicating the financial advisor's estimated business performance during a particular length of time in the future (e.g., ten years in the future, twenty years in the future, or some other time in the future). For example, the chart 522 includes an estimate of the gross dealer concession associated with the sale of the advisory services, an estimate of the gross dealer concession associated with sale of transactional (e.g., non advisory) financial products, and an estimate of the total gross dealer concession.

The forecasting shown in the retailer forecasting sub-element 520 depends, at least in part, on the historical performance of the financial advisor, and assumed performance characteristics for the financial advisor moving forward. For example, the forecast can depend on current business performance of the financial advisor, an assumed recapture rate for the financial advisor, an assumed advisory growth rate for the financial advisor, and an assumed transactional growth rate for the financial advisor.

The assumed recapture rate is an estimate of the rate at which assets that are surrendered from the plan sponsor business and are considered eligible to move to a retail product (e.g., a client's rollover-eligible assets) are “recaptured” into a retail product. As an example, a client having assets in a particular company's retirement and annuity products (e.g., as summarized in the sponsor and demographic sub-element 320) might decide to withdraw those assets from the company sponsored retirement plan (e.g., a 403b, 457, or 401k retirement plan), resulting in “surrendered” assets. Instead of completely withdrawing the assets from the financial advisor's management, she may choose instead to transfer those assets into a retail product offered by the financial advisor, resulting in a “recaptured” asset. The recapture rate is a measure of the rate in which these assets are recaptured. The assumed recapture rate can be determined, in some cases, by averaging the financial advisor's rate of recapture over a period of time in the past (e.g., over the past year, two years, three years, or any other time period). In some cases, the assumed recapture rate can be set to a particular default value (e.g., 0%).

The assumed advisory growth rate is an estimate of the rate at which the financial advisor will increase his sales of advisory services to clients. In some cases, the assumed advisory growth rate can be determined based on historical information. For example, the assumed advisory growth rate can be calculated by averaging the rate of the financial advisor's rate of sales growth of advisory services over a period of time in the past. This information can be used to determine any recaptured advisory GDC and to obtain a pure external GDC calculation (e.g., over the past year, two years, three years, or any other time period). In some cases, the assumed advisory growth rate can be set to a particular default value (e.g., 0%).

The assumed transactional growth rate is an estimate of the rate at which the financial advisor will increase his sales of transactional services to clients (e.g. IRAs, mutual funds, life insurance, and disability insurance). In some cases, the assumed transactional growth rate can be determined based on historical information. For example, the assumed transactional growth rate can be calculated by averaging the rate of the financial advisor's rate of sales growth of transactional services over a period of time in the past (e.g., over the past year, two years, three years, or any other time period). In some cases, the assumed transactional growth rate can be set to a particular default value (e.g., 0%).

In some cases, a user can override the calculated or default values by entering override values input the input fields 524. For example, the user can enter a new assumed recapture rate, a new assumed advisory growth rate, and/or a new assumed transactional growth rate. In response to the user entering one or more override values, the information in the chart 524 automatically updates to reflect the new assumed values. This allows the user to forecast how his business performance based on one or more hypothetical situations, or incorporate individualized assumptions for future performance.

Referring to FIG. 5D, the combined income forecasting sub-element 530 includes a forecast of the financial advisor's compensation. As described above, in some cases, the financial advisor's compensation can depend on a combination of factors, including his business performance in providing products and services pertaining to a particular company or organization (e.g., particular a company or organization offering particular retirement and annuity products), and his business performance in providing retail products and services not directly associated with that company or that company's products.

In the example shown in FIG. 5D, the combined income forecasting sub-element 530 includes a chart 532 indicating the financial advisor's estimated compensation for a particular length of time in the future (e.g., ten years in the future, twenty years in the future, or some other time in the future). For example, the chart 532 includes an estimate of the income the financial advisor will receive in connection with selling products and services pertaining to a particular company or organization, an estimate of the income the financial advisor will receive in connection with providing retail products and services not directly associated with that company or that company's products, and an estimate of the total income the financial advisor will receive (e.g., a sum of the individual estimated incomes above net expenses). In some cases, the chart 532 can include an estimate of the total income the financial advisor will receive based on expense information entered by a user (e.g., using the input user interface element 400 shown in FIG. 4).

The forecasting shown in the retailer forecasting sub-element 520 depends, at least in part, on the historical performance of the financial advisor, and assumed performance characteristics for the financial advisor moving forward. For example, the forecast can depend on current business performance of the financial advisor, an assumed rate of expense inflation for the financial advisor, and commission rate to the financial advisor for her services (e.g., a percentage of premium, a percentage of total GDC, a percentage of sales, and a percentage of assets paid for each particular situation/product sold).

The assumed rate of expense inflation is an estimate of the rate at which the financial advisor's expenses will increase in the future. In some cases, the assumed rate of expense inflation can be determined based on historical information. For example, the assumed rate of expense inflation can be calculated by averaging the rate in which the financial advisor's expenses increased over a period of time in the past (e.g., over the past year, two years, three years, or any other time period). In some cases, the assumed advisory growth rate can be set to a particular default value (e.g., 0%, 3%, or some other value).

In some cases, a user can override the calculated or default values by entering override values input the input fields 534. For example, the user can enter a new assumed rate of expense inflation. In response to the user entering one or more override values, the information in the chart 534 automatically updates to reflect the new assumed values. This allows the user to forecast how his business performance based on one or more hypothetical situations, or incorporate individualized assumptions for future performance.

In some cases, override values entered in each of the sub-elements 510, 520, and 530 potentially can affect any of the charts 512, 522, and 532. For example, as described above, inputting an override value for the estimated surrender rate (e.g., as entered in input fields 514) can affect the financial forecast of aspects of a financial advisor's practice pertaining to a particular company or organization (e.g., the forecast shown in chart 512). However, entering the override value for the estimated surrender rate also can affect the financial forecast of aspects of a financial advisor's practice pertaining to retail products and services (e.g., the forecast shown in chart 522), as well as the forecast the financial advisor's compensation (e.g., the forecast shown in chart 532). Accordingly, the charts 512, 522, and 532 can be updated based on override values entered for the estimated surrender rate.

As another example, as described above, entering an override value for the estimated advisory growth rate (e.g., as entered in input fields 524) can affect the financial forecast of aspects of a financial advisor's practice pertaining to retail products and services (e.g., the forecast shown in chart 522), as well as the forecast of the financial advisor's compensation (e.g., the forecast shown in chart 532). Accordingly, the charts 522 and 532 can be updated based on override values entered for the estimated advisory growth rate.

Accordingly, some or all of the charts 522 and 532 can be updated, depending on whether the override value entered by the user through the user interface affects each forecast.

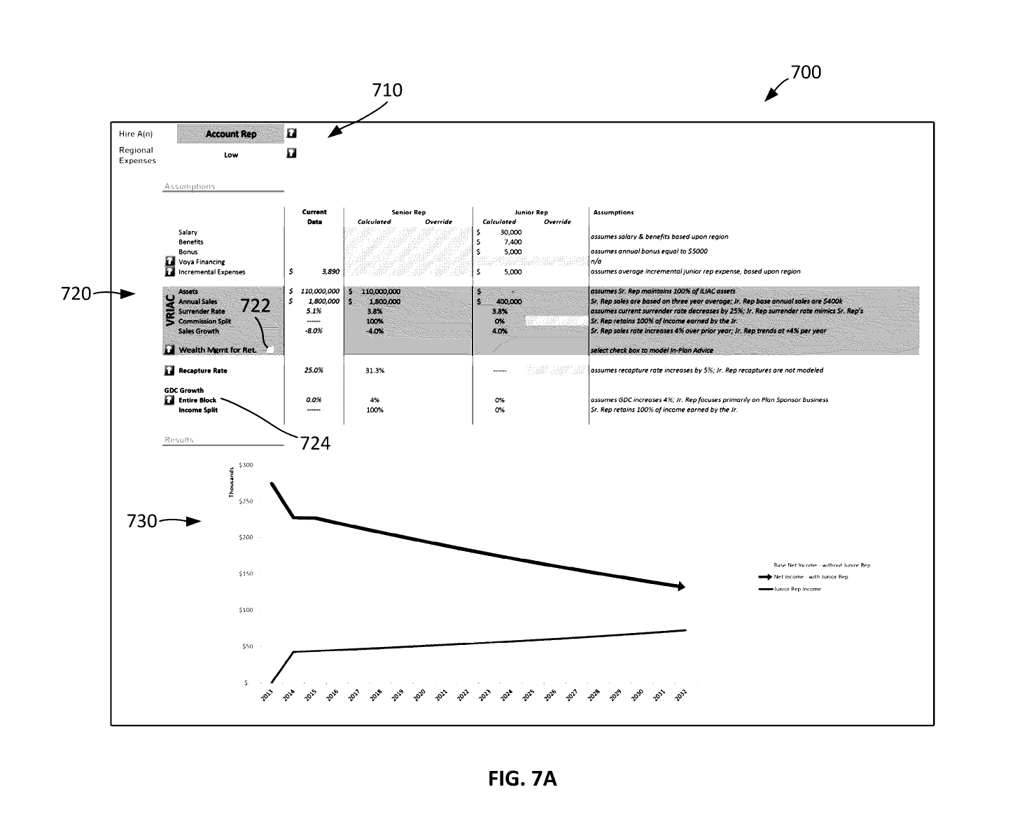

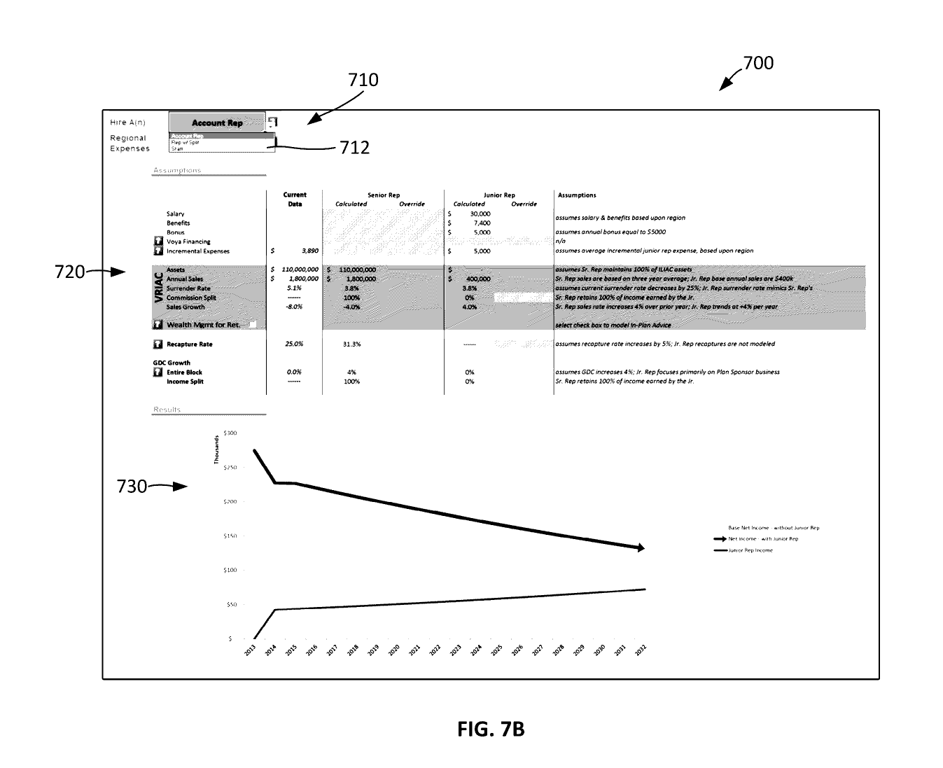

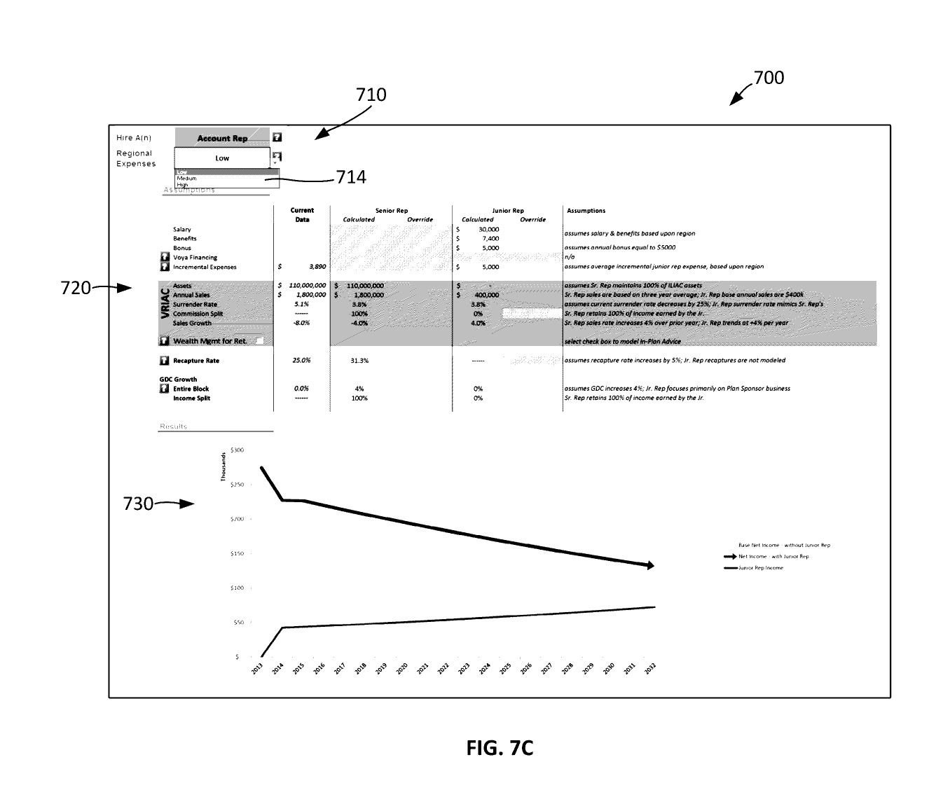

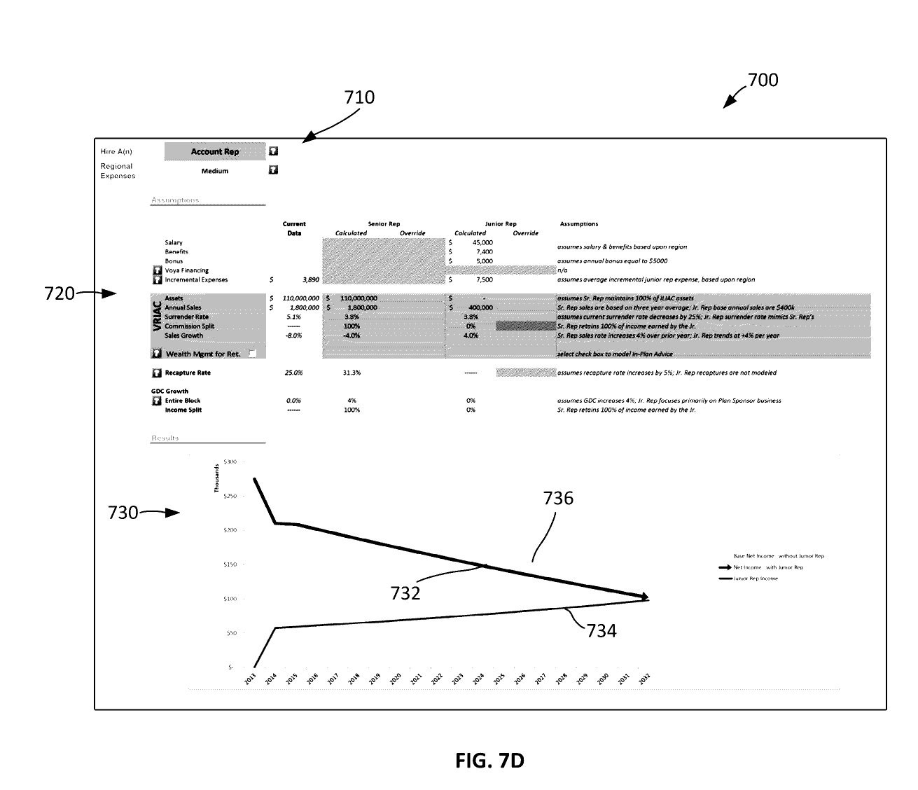

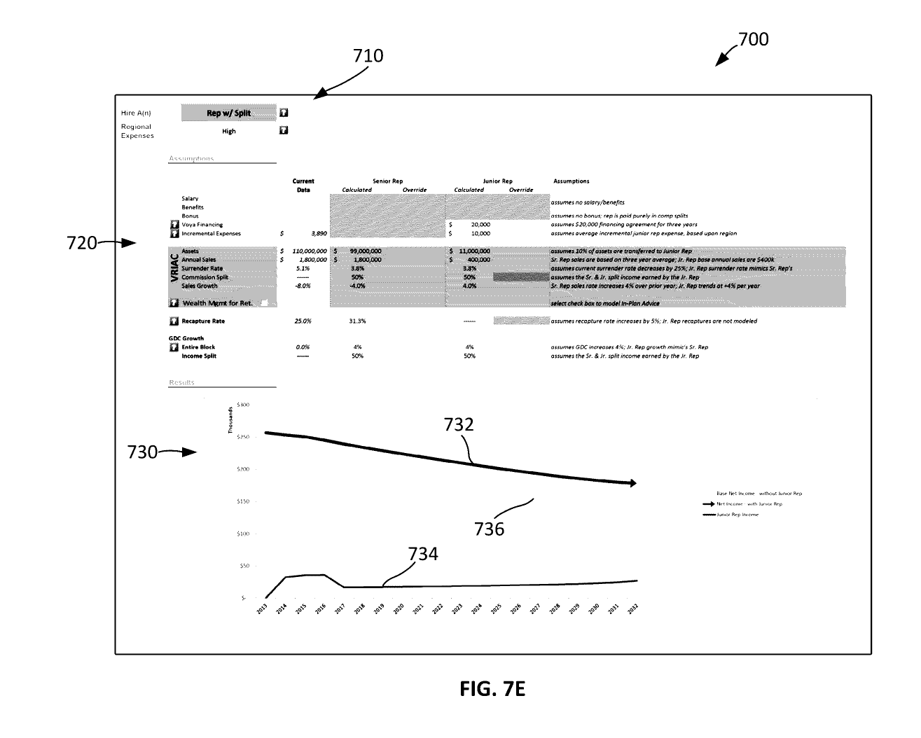

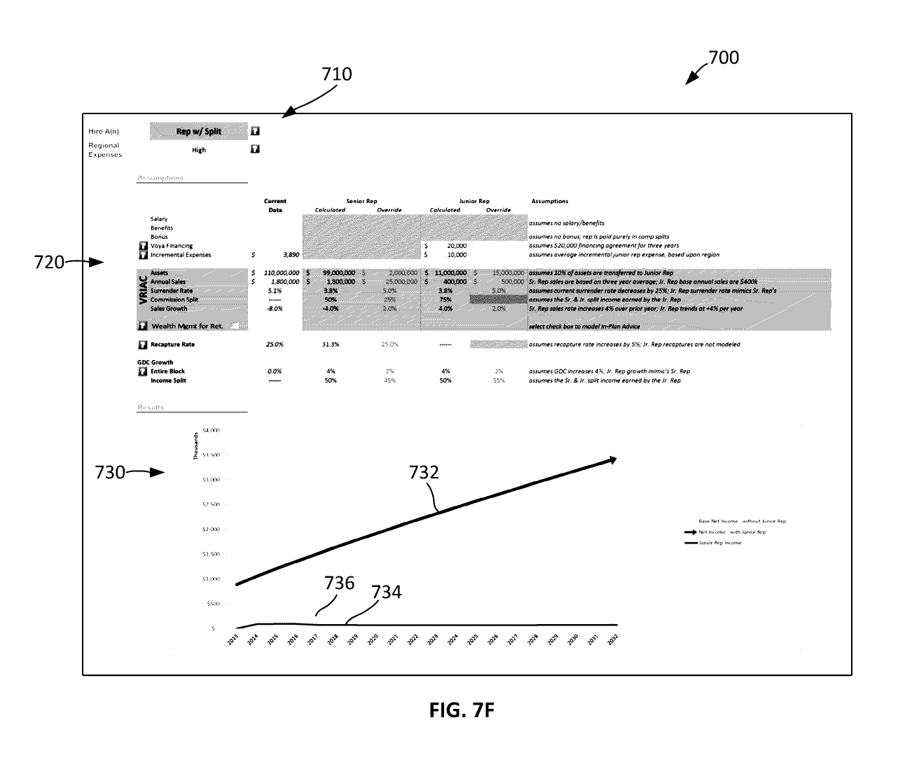

Override values entered in each of the sub-elements 510, 520, and 530 potentially also can affect information shown in other user interface elements. As an example, override values entered in the sub-elements 510, 520, and/or 530 can affect information shown in a hiring forecasting user interface element 700, as described in greater detail with respect to FIGS. 7A-F.

Although various information, inputs, and forecasts are described above, these are merely illustrative examples. In practice, the business forecasting user interface element 500 can include other information, inputs, and forecasts, either in addition to or instead of those described above.

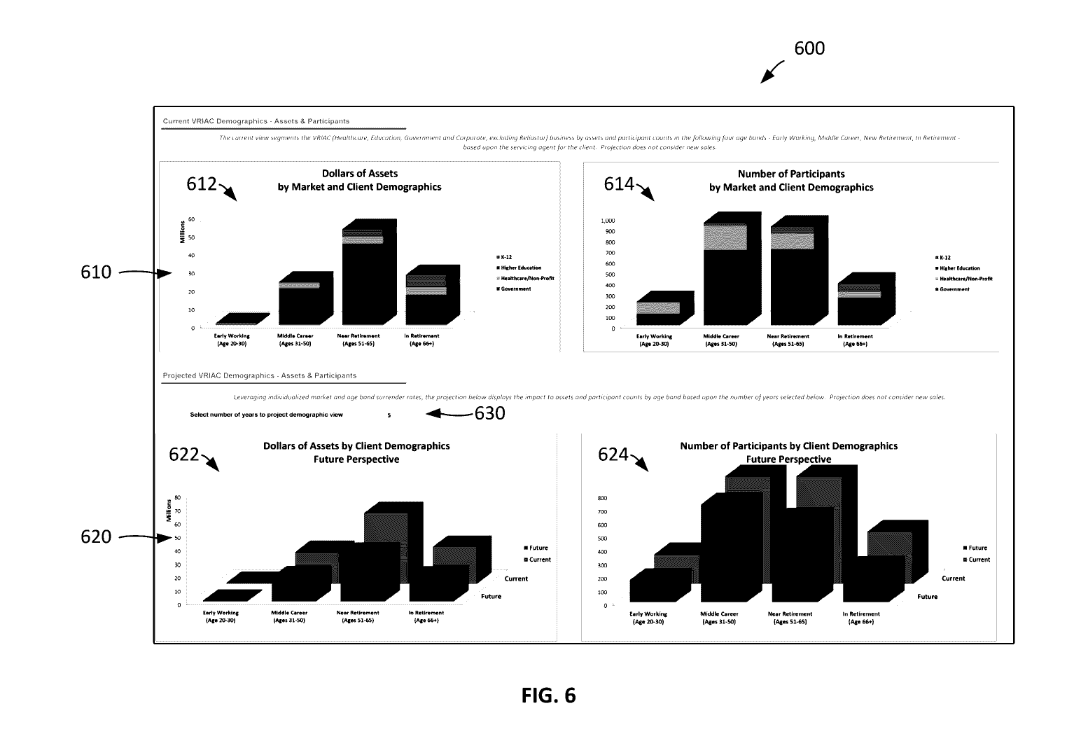

The analysis module 140 also can forecast the demographics of a financial advisor's clients. An example client demographic user interface element 600 is shown in FIG. 6. The client demographic user interface element 600 can include one or more sub-elements each of which presents a particular type of information. For example, the client demographic user interface element 600 can include a current client composition sub-element 610 and a projected client composition sub-element 620.

In general, the information shown in the client demographic user interface element 600 can be determined, at least in part, based on information stored in the database sub-module 210. For example, the database sub-module 210 can contain records describing each aspect of a financial advisor's practice, including records of the assets managed by the financial advisor, the transactions conducted with respect to those assets, the clients associated with the assets, and so forth. Using these records, the processing sub-module 220 can generate the appropriate information for display on the client demographic user interface element 600. Records describing the financial advisor's practice can be automatically obtained (e.g., from a record keeping module on the server system 110 or from a record keeping system communicatively coupled to the system 100), and/or manually entered by a user (e.g., a user inputting data using the server system 110, client computers 120a-b, or some other device).

The current client composition sub-element 610 shows a summary of the current composition of a financial advisor's clients (e.g., as shown in panel 614) and the division of assets between those clients (e.g., as shown in panel 612). For example, the panel 614 shows the number of clients that are within particular age categories (e.g., 20-30 years of age, 31-50 years of age, 51-65 years of age, and 66 years of age and older), and the client composition of each of those age categories (e.g., whether the clients are associated with a K-12 market, a higher education market, a healthcare/non-profit market, or a government market). Similarly, the panel 612 shows the value of assets held by clients within each of the particular age categories, and value of the assets held by each of the different types of clients in those age categories. In FIG. 6, the data is shown using bar graphs. In other implementations, the data may be illustrated in other ways.

The projected client composition sub-element 620 shows a forecast of the future composition of a financial advisor's clients (e.g., as shown in panel 624) and the division of assets between those clients (e.g., as shown in panel 622) based upon historical information (e.g., historical information describing a company-level surrender rate by demographic). For example, the panel 624 shows the projected number of clients that are within particular age categories (e.g., 20-30 years of age, 31-50 years of age, 51-65 years of age, and 66 years of age and older) at some point in the future (e.g., one year, five years, or any other amount of time in the future), and the client composition of each of those age categories (e.g., whether the clients are associated with a K-12 market, a higher education market, a healthcare/non-profit market, or a government market) at that point in the future. Similarly, the panel 622 shows the projected value of assets held by clients within each of the particular age categories at that point in the future, and value of the assets held by each of the different types of clients in those age categories.

Although the example client demographic user interface element 600 shows forecasts for a single point of time in the future, in some implementations, the user can select different points of time and view forecasts for those selected points of time. For example, the user can enter different points of time into an input field 630 (e.g., between one to twenty years in the future) in order to view forecasts for the inputted points of time in the future.

Further, although various information, inputs, and forecasts are described above, these are merely illustrative examples. In practice, the client demographic user interface element 600 can include additional information, inputs, and forecasts, either in addition to or instead of those described above. For example, although example age and market categories are shown, one or more additional categories also can be used, either in addition to or instead of these age and market categories (e.g., different age ranges, different market categories, or different categories altogether). In addition, forecast modeling could be based, for example, on multiple sets of assumptions, each determined based on different historical information. For example, in some cases, historical information for a company as a whole can be used to determine a first set of assumptions, and historical information regarding one or more specific financial advisors can be used to determine a second set of assumptions. Each set of assumptions can be used to generate a respective forecast and compared.

The analysis module 140 also can forecast the effects of a financial advisor hiring new employees to assist him in his practice. An example hiring forecasting user interface element 700 is shown in FIG. 7A. The hiring forecasting user interface element 700 can include one or more sub-elements each of which presents a particular type of information. For example, the hiring forecasting user interface element 700 can include input fields 710 for selecting a type of employee to hire hypothetically, input fields 720 for specifying the assumed performance characteristics of the hired employee, and a chart 730 describing the forecasted effects of hiring that employee.

In general, the information shown in the hiring forecasting user interface element 700 can be determined, at least in part, based on information stored in the database sub-module 210, as well based on any data entered by a user (e.g., override values entered on the hiring forecasting user interface element 700 or elsewhere) For example, the database sub-module 210 can contain records describing each aspect of a financial advisor's practice, including records of the assets managed by the financial advisor, the transactions conducted with respect to those assets, the clients associated with the assets, and so forth. Using these records, the processing sub-module 220 can generate the appropriate information for display on the hiring forecasting user interface element 700. Records describing the financial advisor's practice can be automatically obtained (e.g., from a record keeping module on the server system 110 or from a record keeping system communicatively coupled to the system 100), and/or manually entered by a user (e.g., a user inputting data using the server system 110, client computers 120a-b, or some other device).

The input fields 710 allow a user to select a particular type of employee to hire hypothetically. For example, referring to FIG. 7B, the inputs fields 710 can provide the user with a drop-down menu 712 listing several different types of employees (e.g., an account representative paid by a commissions system, an account representative paid by business splits of book of business changes, or support staff). Referring to FIG. 7C, the input fields 710 also can provide the user with a drop-down menu 714 listing several different levels of regional expenses (e.g., “low,” “medium,” and “high”). Using the drop-down menus 712 and 714, the user can select a type of employee of employee that she wishes to hire hypothetically, and a level of region expenses associated with that hypothetical employee (e.g., whether the hypothetical employee is being hired in a region having a low local cost of living, a medium local cost of living, or high local cost of living). Regional expenses also could be driven, for example, based on historical data from other financial advisor's practices who live in the same region, have the same type of business model, or support the same type of business.

The information in the chart 730 updates automatically in response to the user's selection. For example, referring to FIG. 7D, if the user selected an account representative paid by a commissions system (e.g., by selecting “Account Rep” from the drop-down menu 712) and a medium level of region expenses (e.g., by selecting “Medium” from the drop-down menu 714), the chart 730 is revised to reflect the forecasted business performance of the financial advisor's practice if she were to hire such an employee. For example, the chart 730 includes a plot 732 depicting the projected net income (e.g., profitability) of the practice as a result of the hiring, and a plot 734 depicting the projected income for the hired employee. For comparison purposes, the chart 730 also includes a plot 736 depicting the base net income reflecting the projected net income of the practice if the employee was not hired.

As the user selects different employees and/or regional expenses, the chart 730 updates to reflect the selections. For example, referring to FIG. 7E, if the user selected an account representative paid by business splits of book of business changes (e.g., by selecting “Rep w/ Split” from the drop-down menu 712) and a high level of region expenses (e.g., by selecting “High” from the drop-down menu 714), the chart 730 is revised to reflect the forecasted business performance of the financial advisor's practice if she were to hire such an employee (e.g., by repopulating the chart 730 with updated information). For example, the plots 732 and 734 can be revised to reflect the hiring of the selected employee. Thus, the user (e.g., a financial advisor) can simulate the hiring of various types of employees, and forecast the impact of those hirings on the business performance of his practice.

The information in the chart 730 also can update automatically in response to the user's selections and inputs from other interface elements. For example, override values entered into user interface elements other than the user interface element 700 (e.g., the user interface element 500 shown in FIG. 5) can be used to automatically update the chart 730.

The input fields 720 display assumed performance characteristics for each type of employee that the financial user might hypothetically hire. These assumed performance characteristics can be, for example, based on the historical performance of employees that are and were employed by the financial advisor, overall performance assumptions of similar individuals hired by the company as a whole (e.g., as summarized in input fields 720 shown in FIG. 7), or user entered overrides (e.g., as inputted by a user through the user interface elements 500 and/or 700). For example, the input fields 720 can display an expected salary, benefits, bonus, and expenses for one or more of the employees. The input fields 720 also can display information regarding the projected performance of the employees with respect to the financial advisor's different aspects of practice (e.g., the employee's projected performance in selling particular products or services offered by a particular company, or selling retail products and services that are not directly associated with that company). This data can be coupled with assumptions for future performance in order to automatically update company and retail assumptions for modeling future growth. For example, the input fields 720 can include information regarding the value of assets that are expected to be managed by an employee, the annual sales projected to be made by the employee, the surrender rate of the employee, the expected commission split for the employee (e.g., the percentage of a commission that is split between a junior representative and a supervising senior representative), and the expected sales growth of the employee. As another example, the input fields 720 also can include a projected recapture rate for the employee, a projected gross dealer concession growth rate for the employee, and the expected income split of the employee (e.g., the percentage of income that is split between a junior representative and a supervising senior representative). In some cases, a hypothetical employee's performance can be modeled based on the historical performance of employees in a particular aspect of practice (e.g., company vs. retail), or based on the historical performance across an entirety of practice (e.g., both company and retail). This information also can be overridden by the user based on his own hypothetical assumptions.

As discussed above, each of the aforementioned characteristics can be determined based on the historical performance of employees that are, and were, employed by the financial advisor. In some cases, a user can override the calculated or default values by entering override values (e.g., in the input fields 710 and 720). In response to the user entering one or more override values, the information in the chart 730 automatically updates to reflect the new assumed values. For example, referring to FIG. 7F, the user can enter override values for each of the calculated or default values shown in the input fields 710 and 720 (e.g., by inputting the override values in the provided input boxes). In response to the user entering the override values, the information in the chart 730 automatically updates to reflect the inputted override values. For example, the plots 732, 734, and 736 can be revised to reflect the inputted override values. This allows the user to forecast how his business performance based on one or more hypothetical situations, or incorporate individualized assumptions for future performance.

In addition, users can select added features to further refine hypothetical performance of future scenarios. For example, referring to FIG. 7A, a user can select an input element 722 (e.g., a “check box” in the input field 720) in order to specify that additional modeling be conducted based on particular services offered by the company (e.g., particular wealth management services offered by the company). As another example, a user can specify that the hypothetical growth of retail business be modeled based on advisory services only, based on transactional services only, or based on the entire block of business by selecting an appropriate input element 724 (e.g., a drop down menu).

Although various information, inputs, and forecasts are described above, these are merely illustrative examples. In practice, the hiring forecasting user interface element 700 can include additional information, inputs, and forecasts, either in addition to or instead of those described above.

Further, although a particular arrangement of the system 100 is shown in FIG. 1, this is merely an illustrative example. In practice, different arrangements are also possible, depending on the implementation. Further still, in some cases, one or more of the components of the system 100 need not be present.

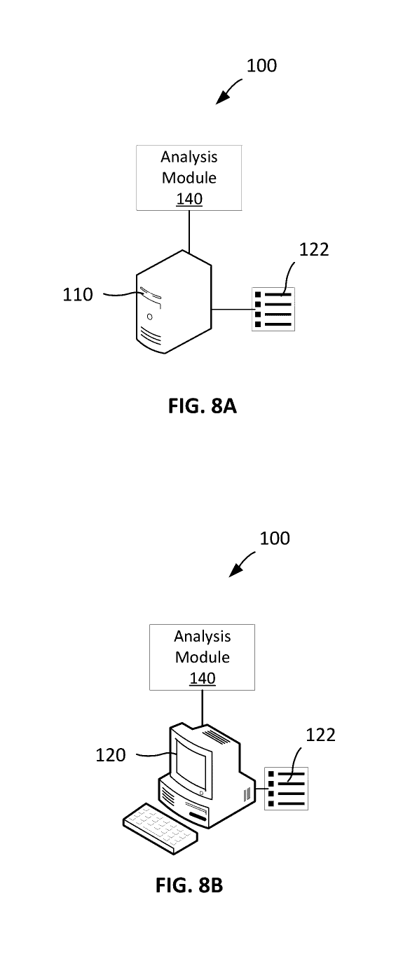

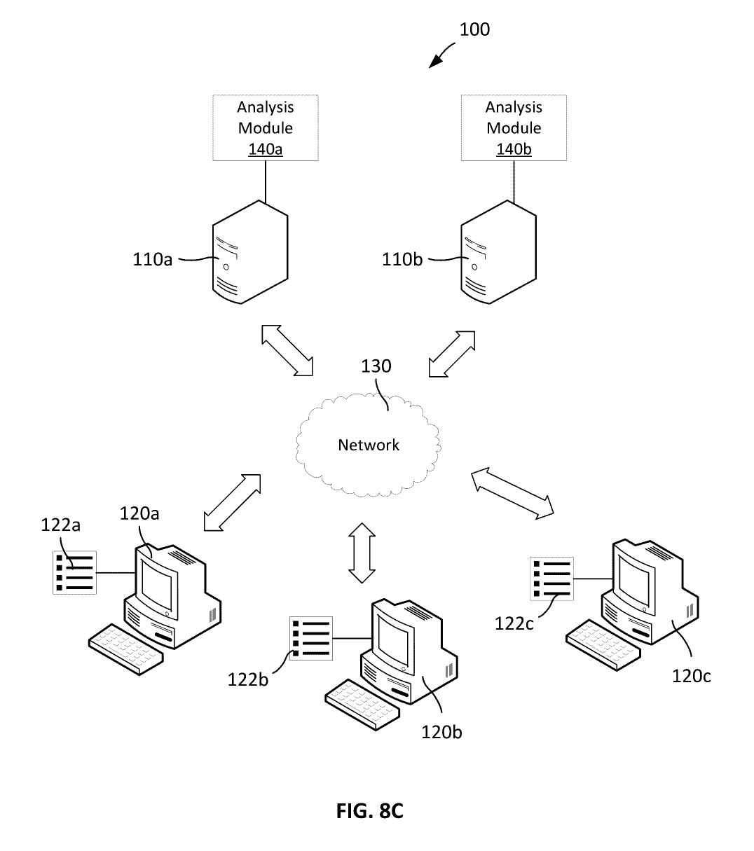

For instance, another example arrangement of the system 100 is shown in FIG. 8A. In this example, the system 100 includes a server system 110, and does not include any client devices. Instead, a user interface 122 is provided on the server system 110. Thus, a user can access the analysis module 140 by directly accessing the user interface 122 provided on the server system 110.

Another example arrangement of the system 100 is shown in FIG. 8B. In this example, the system 100 includes a client system 120, and does not include any service systems. Instead, an analysis module 140 is provided on the client device 120. Thus, a user can access the analysis module 140 by accessing the user interface 122 provided on the client device 110.

Another example arrangement of the system 100 is shown in FIG. 8C. In this example, the system 100 includes two server systems 110a-b, each providing an analysis module 140a-b. The system 100 also includes several client systems 120a-c, each of which provides a respective user interface 122a-c. Thus, multiple users can access either or both of the analysis modules 140a-b by accessing the user interfaces 122a-c provided on the client devices 110a-c.

Although several system configurations are shown above, these are only examples to illustrate some arrangements of a system 100. In practice, other system configurations are possible, depending on the implementation.

Although example implementations for monitoring and forecasting a single financial advisor's business performance are described herein, these examples are provided merely to illustrate the aforementioned concepts. In practice, some implementations can be used to monitor and forecast multiple financial advisors' business performances, and present customized information regarding each financial advisor. For example in some cases, a single system can be used to monitor several financial advisor's professional practices in order to provide customized historical, current, and projected information regarding each practice's individual or collective business performance.

In some cases, customized information can be provided by selecting filtering information based on the user interacting with the system 100. For example, if a particular financial advisor is interacting with the system 100, the system 100 can provide information that is customized specifically for that financial advisor (e.g., by generating summary and forecast information regarding that particular financial advisor's practice). Information that is not relevant to that financial advisor (e.g., information regarding other financial advisors' practices) can be hidden or otherwise rendered inaccessible from the user. Thus, the system 100 can store information regarding several users and their practices, and can provide information selectively depending on the relevance of that information to the present user.

As another example, if a supervisor is interacting with the system 100, the system 100 can provide information that is customized specifically for the financial advisors that the supervisor oversees (e.g., by generating individual information for each of the financial advisors individually and/or generating individual information for the financial advisors collectively). If information regarding more than one financial advisor is available to a user, the user can selectively filter the presented information, such that only the desired information is visible. Some implementations of subject matter and operations described in this specification can be implemented in digital electronic circuitry, or in computer software, firmware, or hardware, including the structures disclosed in this specification and their structural equivalents, or in combinations of one or more of them. For example, in some implementations, server systems 110 and 110a-b, client devices 120 and 120a-c, and analysis modules 140 and 140a-b can be implemented using digital electronic circuitry, or in computer software, firmware, or hardware, or in combinations of one or more of them.

As described above, although some implementations for monitoring and forecasting the business performance of a financial advisor are described and illustrated, these are provided merely as illustrative examples. Some implementations can be used to monitor and forecast the business performance of one or more other types of financial service providers, including financial institutions, investment brokers, or other individuals or organizations. Further, some implementations can be used to monitor and forecast the business performance of portions of one or more financial services providers.

Some implementations described in this specification can be implemented as one or more groups or modules of digital electronic circuitry, computer software, firmware, or hardware, or in combinations of one or more of them. Although different modules can be used, each module need not be distinct, and multiple modules can be implemented on the same digital electronic circuitry, computer software, firmware, or hardware, or combination thereof.

Some implementations described in this specification can be implemented as one or more computer programs, i.e., one or more modules of computer program instructions, encoded on computer storage medium for execution by, or to control the operation of, data processing apparatus. A computer storage medium can be, or can be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially generated propagated signal. The computer storage medium also can be, or be included in, one or more separate physical components or media (e.g., multiple CDs, disks, or other storage devices).

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application specific integrated circuit). The apparatus also can include, in addition to hardware, code that creates an execution environment for the computer program in question, e.g., code that constitutes processor firmware, a protocol stack, a database management system, an operating system, a cross-analysis runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages. As example, a computer program can be written in one or more of C, Java, Object-C, C++, C#, PHP, JavaScript, Python, Visual Basic, Perl, and/or any other suitable language. In some cases, a computer program can be partially or entirely written using macros that specify how certain input sequences should be mapped to a particular output sequences. In some cases, a computer program can be implemented as a part of another computer program, such as a general purpose office productivity application. As an example, a computer program can be written such that it can be executed by a general purpose spreadsheet application (e.g., Microsoft Excel), a general purpose word processor application (e.g., Microsoft Word), or a general purpose database application (e.g., Microsoft Access).

A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

Some of the processes and logic flows described in this specification can be performed by one or more programmable processors executing one or more computer programs to perform actions by operating on input data and generating output. The processes and logic flows also can be performed by, and apparatus also can be implemented as, special purpose logic circuitry, e.g., an FPGA (field programmable gate array) or an ASIC (application specific integrated circuit).

Processors suitable for the execution of a computer program include, by way of example, both general and special purpose microprocessors, and processors of any kind of digital computer. Generally, a processor will receive instructions and data from a read only memory or a random access memory or both. A computer includes a processor for performing actions in accordance with instructions and one or more memory devices for storing instructions and data. A computer may also include, or be operatively coupled to receive data from or transfer data to, or both, one or more mass storage devices for storing data, e.g., magnetic, magneto optical disks, or optical disks. However, a computer need not have such devices. Devices suitable for storing computer program instructions and data include all forms of non-volatile memory, media and memory devices, including by way of example semiconductor memory devices (e.g., EPROM, EEPROM, flash memory devices, and others), magnetic disks (e.g., internal hard disks, removable disks, and others), magneto optical disks, and CD ROM and DVD-ROM disks. The processor and the memory can be supplemented by, or incorporated in, special purpose logic circuitry.

To provide for interaction with a user, operations can be implemented on a computer having a display device (e.g., a monitor, or another type of display device) for displaying information to the user and a keyboard and a pointing device (e.g., a mouse, a trackball, a tablet, a touch sensitive screen, or another type of pointing device) by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

A computer system may include a single computing device, or multiple computers that operate in proximity or generally remote from each other and typically interact through a communication network. Examples of communication networks include a local area network (“LAN”) and a wide area network (“WAN”), an inter-network (e.g., the Internet), a network comprising a satellite link, and peer-to-peer networks (e.g., ad hoc peer-to-peer networks). A relationship of client and server may arise by virtue of computer programs running on the respective computers and having a client-server relationship to each other.

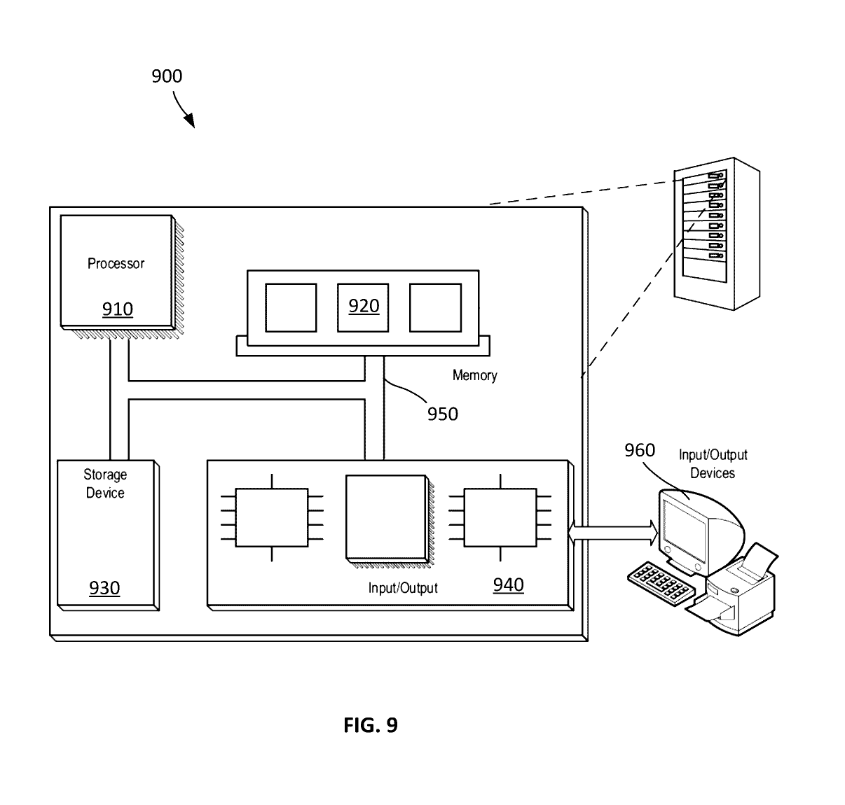

FIG. 9 shows an example computer system 900 that includes a processor 910, a memory 920, a storage device 930 and an input/output device 940. Each of the components 910, 920, 930 and 940 can be interconnected, for example, by a system bus 950. The processor 910 is capable of processing instructions for execution within the system 900. In some implementations, the processor 910 is a single-threaded processor, a multi-threaded processor, or another type of processor. The processor 910 is capable of processing instructions stored in the memory 920 or on the storage device 930. The memory 920 and the storage device 930 can store information within the system 900.

The input/output device 940 provides input/output operations for the system 900. In some implementations, the input/output device 940 can include one or more of a network interface devices, e.g., an Ethernet card, a serial communication device, e.g., an RS-232 port, and/or a wireless interface device, e.g., an 802.11 card, a 3G wireless modem, a 4G wireless modem, etc. In some implementations, the input/output device can include driver devices configured to receive input data and send output data to other input/output devices, e.g., keyboard, printer and display devices 960. In some implementations, mobile computing devices, mobile communication devices, and other devices can be used.

While this specification contains many details, these should not be construed as limitations on the scope of what may be claimed, but rather as descriptions of features specific to particular examples. Certain features that are described in this specification in the context of separate implementations also can be combined. Conversely, various features that are described in the context of a single implementation also can be implemented in multiple embodiments separately or in any suitable subcombination.

A number of implementations have been described. Nevertheless, it will be understood that various modifications may be made without departing from the spirit and scope of the invention. Accordingly, other implementations are within the scope of the following claims.

What is claimed is:

1. A method comprising:
presenting visually, on an interactive user interface, information representing one or more historical metrics and projected performance for a particular provider of a financial service;
receiving, via the interactive graphical user interface, one or more inputs from a user;
updating the projected performance of the particular provider based on the inputs received from the user; and
presenting visually, on the interactive user interface, the updated projected performance of the particular provider.

2. The method of claim 1, wherein the one or more inputs from the user comprise information pertaining to a projected hiring of an employee.

3. The method of claim 2, wherein the one or more inputs from the user further comprise information pertaining to a projected regional expense associated with the hiring of the employee.

4. The method of claim 2, wherein updating the projected performance of the particular provider based on the inputs received from the user comprises:
determining the projected performance of the particular provider in hiring the employee.

5. The method of claim 1, wherein the one or more historical metrics comprises at least one member of a group consisting of a historical surrender rate, a historical sales growth rate, and a historical recapture rate.

6. The method of claim 1, wherein the one or more inputs from the user comprise at least one override value corresponding to a historical metric; and
wherein updating the projected performance of the particular provider based on the inputs received from the user comprises:
replacing one of the historical metrics with a corresponding override value; and
re-determining the projected performance of the particular provider based at least on the override value and unmodified historical metrics of the particular provider.

7. The method of claim 1, wherein the one or more inputs from the user comprise at least one override value corresponding to an anticipated future metric for the particular provider; and
wherein updating the projected performance of the particular provider based on the inputs received from the user comprises:
re-determining the projected performance of the particular provider based at least on the anticipated future metric and the historical metrics of the particular provider.

8. The method of claim 1, wherein the historical metrics for the particular provider are determined based on information regarding one or more clients of the particular provider, assets associated with those one or more clients, and financial transactions associated with those one or more clients.

9. The method of claim 1, wherein the projected performance of the particular provider comprises at least one member of a group consisting of a projected income of the particular provider, a projected revenue generated by the particular provider, a projected profitability of a particular provider, and a projected value of assets managed by the particular provider.

10. The method of claim 1, wherein the projected performance of the particular provider comprises projected demographics of the particular provider's clients.

11. The method of claim 10, wherein the projected demographics comprise a projected number of clients in each of a plurality of categories.

12. The method of claim 11, wherein the categories comprise a plurality of different age ranges.

13. The method of claim 10, wherein the projected demographics comprise a projected value of assets associated with clients in each of a plurality of categories.

14. An apparatus comprising:
an interactive user interface;
a processor; and
a computer-readable medium storing instructions, which, when executed by the processor, causes the processor to perform operations comprising:
presenting visually, on the interactive user interface, information representing one or more historical metrics and projected performance for a particular provider of a financial service;
updating the projected performance of the particular provider based on inputs entered by the user via the interactive graphical interface; and
presenting visually, on the interactive user interface, the updated projected performance of the particular provider.

15. The apparatus of claim 14, wherein the one or more inputs from the user comprise information pertaining to a projected hiring of an employee.

16. The apparatus of claim 15, wherein the one or more inputs from the user further comprise information pertaining to a projected regional expense associated with the hiring of the employee.

17. The apparatus of claim 15, wherein updating the projected performance of the particular provider based on the inputs received from the user comprises:
determining the projected performance of the particular provider in hiring the employee.

18. The apparatus of claim 14, wherein the one or more historical metrics comprises at least one member of a group consisting of a historical surrender rate, a historical sales growth rate, and a historical recapture rate.

19. The apparatus of claim 14, wherein the one or more inputs from the user comprise at least one override value corresponding to a historical metric; and
wherein updating the projected performance of the particular provider based on the inputs received from the user comprises:
replacing one of the historical metrics with a corresponding override value; and
re-determining the projected performance of the particular provider based at least on the override value and unmodified historical metrics of the particular provider.

20. The apparatus of claim 14, wherein the one or more inputs from the user comprise at least one override value corresponding to an anticipated future metric for the particular provider; and
wherein updating the projected performance of the particular provider based on the inputs received from the user comprises:
re-determining the projected performance of the particular provider based at least on the anticipated future metric and the historical metrics of the particular provider.

21. The apparatus of claim 14, wherein the historical metrics for the particular provider are determined based on information regarding one or more clients of the particular provider, assets associated with those one or more clients, and financial transactions associated with those one or more clients.

22. The apparatus of claim 14, wherein the projected performance of the particular provider comprises at least one member of a group consisting of a projected income of the particular provider, a projected revenue generated by the particular provider, a projected profitability of a particular provider, and a projected value of assets managed by the particular provider.

23. The apparatus of claim 14, wherein the projected performance of the particular provider comprises projected demographics of the particular provider's clients.

24. The apparatus of claim 23, wherein the projected demographics comprise a projected number of clients in each of a plurality of categories.

25. The apparatus of claim 24, wherein the categories comprise a plurality of different age ranges.

26. The apparatus of claim 23, wherein the projected demographics comprise a projected value of assets associated with clients in each of a plurality of categories.

27. A system comprising:
a database module configured to store one or more historical metrics pertaining to a plurality of providers of financial services;
an interactive user interface; and
a processing module communicatively coupled to the database module and the interactive user interface, the processing module configured to:
receive, from the database module, one or more historical metrics pertaining to a particular provider;
determine, based on the one or more historical metrics pertaining to a particular provider, a projected performance for the particular provider;
present visually, on the interactive user interface, information representing one or more historical metrics and projected performance for the particular provider;
update the projected performance of the particular provider based on inputs entered by the user via the interactive graphical interface; and
present visually, on the interactive user interface, the updated projected performance of the particular provider.

28. The system of claim 27, wherein the one or more inputs entered by the user comprise information pertaining to a projected hiring of an employee.

29. The system of claim 28, wherein the one or more inputs entered by the user further comprise information pertaining to a projected regional expense associated with the hiring of the employee.

30. The system of claim 27, wherein updating the projected performance of the particular provider based on the inputs entered by the user comprises:
determining the projected performance of the particular provider in hiring the employee.

31. The system of claim 27, wherein the one or more historical metrics comprises at least one member of a group consisting of a historical surrender rate, a historical sales growth rate, and a historical recapture rate.

32. The system of claim 27, wherein the one or more inputs entered by the user comprise at least one override value corresponding to a historical metric; and
wherein updating the projected performance of the particular provider based on the inputs entered by the user comprises:
replacing one of the historical metrics with a corresponding override value; and
re-determining the projected performance of the particular provider based at least on the override value and unmodified historical metrics of the particular provider.

33. The system of claim 27, wherein the one or more inputs entered by the user comprise at least one override value corresponding to an anticipated future metric for the particular provider; and
wherein updating the projected performance of the particular provider based on the inputs entered by the user comprises:
re-determining the projected performance of the particular provider based at least on the anticipated future metric and the historical metrics of the particular provider.

34. The system of claim 27, wherein the historical metrics pertaining to the particular provider are determined based on information regarding one or more clients of the particular provider, assets associated with those one or more clients, and financial transactions associated with those one or more clients.

35. The system of claim 27, wherein the projected performance of the particular provider comprises at least one member of a group consisting of a projected income of the particular provider, a projected revenue generated by the particular provider, a projected profitability of a particular provider, and a projected value of assets managed by the particular provider.

36. The system of claim 27, wherein the projected performance of the particular provider comprises projected demographics of the particular provider's clients.

37. The system of claim 36, wherein the projected demographics comprise a projected number of clients in each of a plurality of categories.

38. The system of claim 37, wherein the categories comprise a plurality of different age ranges.

39. The system of claim 36, wherein the projected demographics comprise a projected value of assets associated with clients in each of a plurality of categories.
